(19) United States
(12) Patent Application Publication
(10) Pub. No.: US 2013/0077699 A1
(43) Pub. Date: Mar. 28, 2013

(54) METHODS AND SYSTEMS FOR CONTROL, MANAGEMENT AND EDITING OF DIGITAL AUDIO/VIDEO SEGMENT DURATION WITH REMAPPED TIME CODE

(71) Applicant: PRIME IMAGE, Chalfont, PA (US)

(72) Inventors: Christopher Scott Gifford, Nipomo, CA (US); Keith William Schindler, Nipomo, CA (US)

(73) Assignee: PRIME IMAGE, Chalfont, PA (US)

(21) Appl. No.: 13/623,351

(22) Filed: Sep. 20, 2012

Related U.S. Application Data
(60) Provisional application No. 61/538,342, filed on Sep. 23, 2011.

(51) Int. Cl. H04N 21/434

(52) U.S. Cl. CPC H04N 21/4341
USPC 375/240.28

(57) ABSTRACT

Methods and systems are provided for time altering one or more discrete digital audio/video program segments, each program segment having distinct In time and Out time code points. Data from the digital program segments are received from a data source and decoded. The decoded data are modulated as a serial data stream. The modulated decoded data are provided to a time altering processor to remove or duplicate frame positions to time alter the frame sequence. The resulting time altered serial data stream is demodulated to provide buffered program segment data. The buffered and time altered program segments are encoded and provided in a desired file or streaming format. Audio synchronization with the video is maintained by duplication or removal of audio samples corresponding to the duplicated or removed video frames.

### PRIORITY CLAIM

This application claims the benefit of U.S. Provisional Patent Application No. 61/538,342, which was filed on Sep. 23, 2011, by Gifford et al. and titled “Methods and Systems for Control, Management and Editing of Digital Audio/Video Segment Duration with Remapped Time Code.” Provisional Application No. 61/538,342 is hereby incorporated by reference herein in its entirety.

### FIELD OF THE INVENTION

The present invention relates generally to audio/video signal processing and, in particular, to methods and systems for broadcast and playout of video file mediation, including process control, decoding and modulation of digital video files for the purpose of altering the run time and correlative time code of an audio/video program signal or segment.

### BACKGROUND OF THE INVENTION

Broadcast, production and editing workflows are quickly moving to media files versus uncompressed video on tape. Video servers provide playback and record capability, but do not have the ability to control and manage video modulation for the purpose of post-processing the audio/video program and remapping time altered time codes.

### SUMMARY OF THE INVENTION

Methods and systems are provided for time altering one or more discrete digital audio/video program segments, each program segment having distinct In time and Out time code points. Data from the digital program segments are received from a data source and decoded. The decoded data are time modulated as a serial data stream. The modulated decoded data are provided to a time altering processor to remove or duplicate frame positions to time alter the frame sequence. The resulting time altered data stream is demodulated to provide buffered program segment data. The buffered and time altered program segments are encoded and provided as a desired file or streaming format. Audio synchronization with the video is maintained by duplication or removal of audio samples corresponding to duplicated or removed video frames.

The features and advantages of the various embodiments of the invention disclosed herein will be more fully understood and appreciated upon consideration of the following detailed description and the accompanying drawings, which set forth illustrative embodiments of the claimed subject matter.

### BRIEF DESCRIPTION OF THE DRAWINGS

FIG. 1 is a block diagram illustrating a compute module in association with a time processor.

FIG. 2 is a data flow diagram illustrating time alteration of one or more discrete digital audio/video program segments in accordance with the concepts of the present invention.

### DETAILED DESCRIPTION OF THE INVENTION

Audio/video program segments contain associated time code, metadata or corresponding edit control lists that specify the “In” and “Out” time codes for each program segment. Control operations may be specified for each program segment where the following control modes may be applied to each In Point and/or Out Point.

1) Shift—Video segment In Points and Out Points may be offset by a constant amount in order to increase or decrease the “black hole” space between a neighboring segment where additional video content, such as for example commercial advertisements, may be inserted.

2) Trim—Video segment In Points and Out Points may be shifted individually in order to indicate video portions of a segment that are to be deleted when the time altered segments are created. This may be for the purpose of creating increased video content (e.g., commercial advertisement) space between segments.

3) Time Alter—Video segment In Points and Out Points may be repositioned individually in order to compress or expand a video time segment in time.

4) Preferred or Non-Preferred and Held Time Altering Regions—Regions within video segments may be specified where frame dropping or frame duplication for the purpose of time alteration is either preferred or non-preferred or held. When a region is specified as “hold” control, then time alteration may not occur within that region.

Various control modes may be combined in order to produce the desired effects. For example, a second segment's In Point is shifted away from a first segment in order to increase video content (e.g., commercial advertisement) space between the segments, but then the Out Point of the second segment may be time altered in order to compress the second segment so that the final time code of the Out Point of the second segment did not change from the original Out Point. In another example, a segment's Out Point is shifted in order to significantly compress the segment, but a region of the segment that contains critical motion is specified on “hold” mode so that the compression process does not produce undesirable artifacts during the held region of the segment.

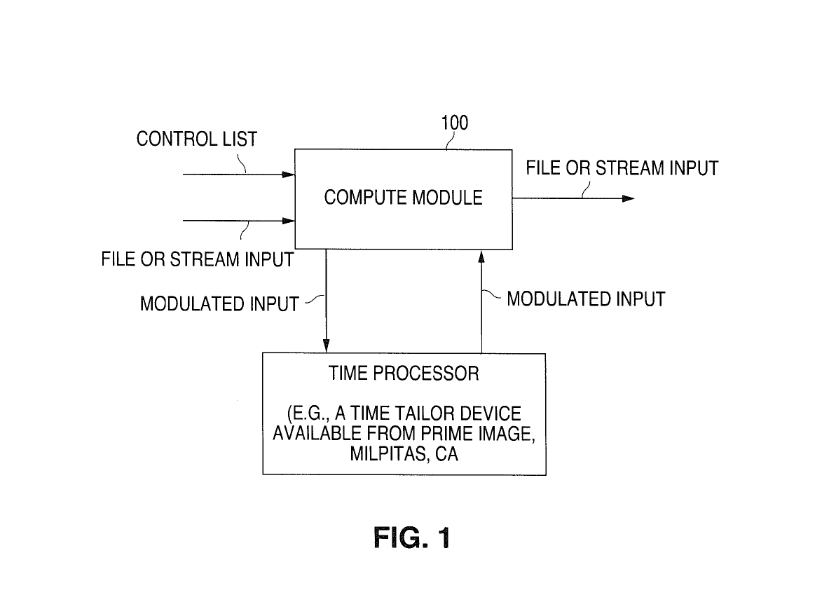

FIG. 1 shows a compute module 100 and an associated time processor 102. The time processor 102 may be, for example, a Time Tailor time processor available from Prime Image, Chalfont, Pa. Please see U.S. Pat. No. 5,995,153, which is hereby incorporated by reference herein in its entirety to provide background information regarding the present invention. Please also see U.S. Pat. No. 7,092,774, which is incorporated by reference herein in its entirety to provide background information regarding the present invention.

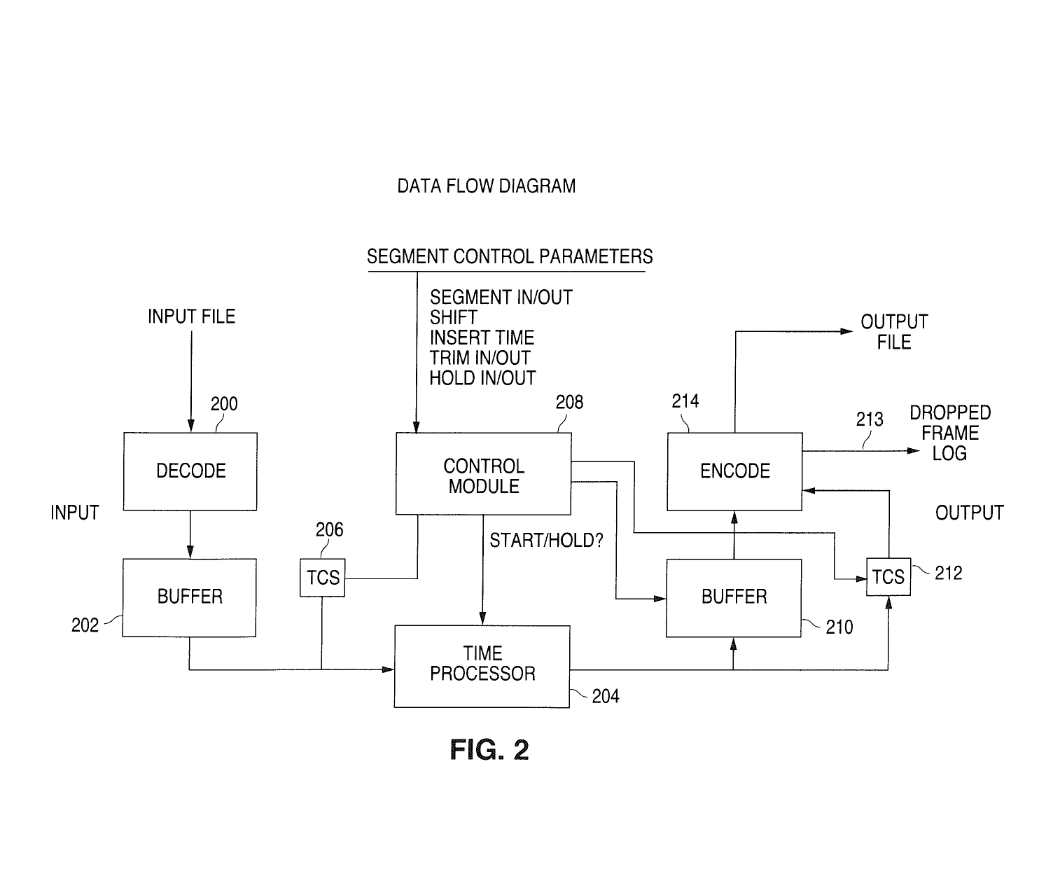

FIG. 2 shows a data flow diagram for altering one or more discrete digital audio/video segments of an audio/video signal.

As shown in FIG. 2, for each segment of the audio/video file or stream, a decode device 200 decodes the segment into a frame buffer 202. The Insert Time and Total Program Time for the segment are set in the Time Processor 204 such that TCout[0]=TCin[0]+ Shift, where TCout[0] is the time code of the first frame in output and TCin[0] is the time code of the first frame in input. The input buffer of frames is then modulated by associating sequential time code 206 received from the control module 208 starting at Segment In and ending at Segment Out.

For each input frame of the segment, if it is a “Trim” frame, then neither the output buffer 210 nor the output time code 212 are advanced when the processed frame is received. If the frame is the first “Time Compressed” frame, then a Start Command is issued to the Time Processor 204. If the frame is the first “Hold” frame after Time Compression is started, then the Time Processor 204 is put in Hold mode. If the frame is the last “Hold” frame, then the Time Processor Hold mode is ended. If the time code received from the Time Processor 204 is the previous time code +2, then the input time code is entered into the dropped frame log 213. The output time code is then mapped to the previous time code +1, unless in the “Trim” mode.

After each frame is processed, an encode device 214 encodes the output frame to the output file or stream.

The following provides an example of input segment processing:

Input Segment:

| | | | |
|---|---|---|---|
| In Point | 00:01 00:00 | Out Point | 00:45 30:00 |

Insert 30 second space before segment (Shift 30:00)
Trim 10 seconds, from 00:01 00:00 to 00:01 10:00
Time Compress segment from 00:01 10:00 to 00:45 30:00 by
dropping 20 seconds
Hold time processing (no dropped frames) between 00:20
40:00 to 00:30 20:00

Resulting Output Segment:

| | | | |
|---|---|---|---|
| In Point | 00:01 30:00 | Out Point | 00:45 30:00 |

| Input | Output | |
|---|---|---|
| 00:01 00:00 | 00:01 30:00 | :Shift |
| 00:01 10:00 | 00:01 30:00 | :Trim |
| 00:01 10:01 | 00:01 30:01 | :Time Compress—not dropped |
| 00:01 10:02 | 00:01 30:01 | :Time Compress—dropped frame |
| 00:01 10:03 | 00:01 30:02 | :Time Compress—not dropped |
| — | — | |
| — | — | :Dropped 12:25 select frames |
| — | — | |
| 00:20 39:29 | 00:20 47:03 | :Time Compress—not dropped |
| 00:20 40:00 | 00:20 47:04 | :Held |
| — | — | |
| — | — | :Held from Time Compress, 9:40 00 |
| 00:30 20:00 | 00:30 27:04 | :Held |
| — | — | |
| — | — | :dropped 07:05 select frames |
| 0045 30:00 | 00:45 30:00 | :Time Compress, not dropped |

Thus, in accordance with embodiments of the invention, a digital audio/video program that includes one or more discrete program segments is cached, decoded and modulated by a Control Module, then passed to Time Processor (e.g., a Time Tailor processor available from Prime Image, Chalfont, Pa.) which alters the duration of the program segments based upon a list of control parameters specified for each segment. The time duration altering process produces dropped or duplicated frames that would otherwise disrupt the original linear progression of time code of each segment that is time altered. In producing the time-altered program segments, the time code is remapped to establish a linear, sequential progression from start to end of each program segment. The original program material is cached to a raw file-based format and may be reprocessed any number of times after editing adjustments are made to alter program segment start and end times, specifying increased or decreased offsets between segment breaks (increasing or decreasing “black holes” for, for example, commercial advertisements), specifying new segment break points, or specifying segment regions that are preferred for frame dropping or duplication, or specifying segment regions that are not preferred (“Held”) from frame dropping or duplication.

The modulated time altered program segments produced by the Time Processor are then fed back to the Compute Module where they are demodulated and encoded to the desired format along with the newly mapped time code. Output program segments may be optionally reviewed on a monitor for evaluation with a user interface, thereby allowing an operator to fine tune segment control settings on a next editing pass.

Digital program material may be ingested into the system in either file-based or streaming format. Time altered program segments may be output from the system in either streaming or file-based format.

Those skilled in the art will appreciate that audio synchronization with the video may be maintained by duplicating or removing an appropriate number of audio samples corresponding to the duplicated or removed video frames

It should be understood that the particular embodiments of the subject matter described above have been provided by way of example and that other modifications may occur to those skilled in the art without departing from the scope of the claimed subject matter as expressed by the appended claims and their equivalents.

What is claimed is:

1. A method of time altering one or more discrete digital audio/video program segments, each program segment having distinct In time and Out time code points , the method comprising:
decoding data of the digital program segments received from a data source;
modulating the decoded data as a serial data stream;
passing the modulated decoded data to a time altering processor to remove or duplicate frame positions in order to time alter the sequences;
demodulating the resulting time altered serial data stream to provide buffered program segment data;
encoding the buffered and time altered program segments to a desired file or streaming format; and
maintaining audio synchronization with the video by duplicating or removing an appropriate number of audio samples corresponding to duplicated or removed video frames.

2. The method of claim 1, and further comprising:
caching the incoming program segments to disk or other storage such that control parameters may be selected over several iterations.

3. The method of claim 1, and further comprising:
shifting the In points or Out points of one or more video segments to alter the time spacing between segments.

4. The method of claim 1, and further comprising:
trimming a specified amount of program time from the beginning and/or end of each program segment.

5. The method of claim 1, and further comprising:
specifying segment regions that are favored, not favored or held for time alteration.

6. The method of claim 1, and further comprising:
remapping linear sequential time code from the beginning to the end of each program segment.

7. A system for time altering one or more discrete digital audio/video program segments, each program segment having distinct In time and Out time code points, the apparatus comprising:
a control interface for ingesting and outputting data;
one or more processors for decoding and encoding data containing audio/video program segments to raw data buffer formats;
one or more data processors for modulating and demodulating raw audio/video buffered data to serial digital format;
a time alteration processor for time altering serial digital audio/video by seamlessly duplicating or removing video frames while maintaining audio synchronization by seamlessly duplicating or removing corresponding audio samples.

8. The system of claim 7, and further comprising:
a storage device for caching the one or more decoded audio/video program segments for processing over multiple sessions.

9. The system of claim 7, and further comprising:
additional control interface for specifying shifts of In point or Out point time codes.

10. The system of claim 7, and further comprising:
additional control interface for specifying trim of In point or Out point time codes.

11. The system of claim 7, and further comprising:
additional control interface for specifying segment regions of favored, non-favored or held time alteration.

12. The system of claim 7, wherein the time alteration processor remaps linear, sequential time code for each time altered audio/video program segment.
